(19) United States
(12) Patent Application Publication
(10) Pub. No.: US 2024/0355130 A1
(43) Pub. Date: Oct. 24, 2024

(54) A METHOD FOR VEHICLE REGISTRATION NUMBER RECOGNITION

(71) Applicant: M2M TECH LIMITED, Didcot, Oxfordshire (GB)

(72) Inventors: Mat SUNDERLAND, Didcot, Oxfordshire (GB); Tim WOOD, Didcot, Oxfordshire (GB); Mark SMITH, Didcot, Oxfordshire (GB)

(73) Assignee: M2M TECH LIMITED, Didcot, Oxfordshire (GB)

(21) Appl. No.: 18/251,512

(22) PCT Filed: Mar. 10, 2022
(86) PCT No.: PCT/GB2022/050621

§ 371 Date: May 2, 2023

(51) Int. Cl. G06V 20/62; G06V 30/19; G07C 9/10

(52) U.S. Cl. CPC G06V 20/62; G06V 30/19007; G07C 9/10; G06V 2201/08

(57) ABSTRACT

A computer-implemented method for vehicle registration number recognition, the method comprising obtaining a vehicle registration number to be recognised and a plurality of authorised vehicle registration numbers, and comparing the vehicle registration number to be recognised with the plurality of authorised vehicle registration numbers, wherein comparing comprises: identifying the number of characters in common between the vehicle registration number to be recognised and each of the plurality of authorised vehicle registration numbers; determining whether the number of characters in common between the vehicle registration number to be recognised and each authorised vehicle registration number is above a pre-determined threshold but less than all characters; and in the event that the number of characters in common between the vehicle registration number to be recognised and at least one authorised vehicle registration number is above the pre-determined threshold, sending a signal that the vehicle registration number is recognised.

### FIELD OF THE INVENTION

The present disclosure relates to a computer-implemented method for vehicle registration number recognition.

### BACKGROUND

Automatic Number Plate Recognition (ANPR) is used in many highway systems, for example including highway access points in which vehicular access is controlled, either virtually or by physical barriers. Example physical barriers may include, but are not limited to, rising bollards, barriers, and/or gates.

In these situations, ANPR cameras read a vehicle's registration number as the vehicles approaches. If the vehicle's registration number is registered on an access list, the vehicle should be granted passage. In the case of a physical barrier, this may involve the physical barrier being removed, for example lowering a rising bollard.

However, the success rate of current ANPR systems is very low, operating with a high percentage of false-negative results. When a vehicle is incorrectly denied access, the driver has to contact an operator which results in increased delays and cost. Two major factors contributing to failure in current ANPR systems are (i) ANPR camera mis-reads, and (ii) incorrect data in the access list.

ANPR camera mis-reads occur when the system returns a vehicle registration number which is close to, but does not match, the actual vehicle registration number to be recognised. Factors contributing to mis-reads may include: predominant or missing screw caps on the vehicle registration plate; where the registration plate is at least partially obscured, for example by marks or dirt; where the registration plate broken or cracked; illegal registration plate fonts; sub-optimal lighting conditions, or environmental reflections.

Incorrect data in the access list may arise where the data has been mis-recorded at the time of gathering, or mis-entered into the access list, for example resulting from human error and/or typographical errors.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

An “Automatic Number Plate Recognition” (ANPR) device refers to a device that uses computer vision to analyse an image of a vehicle and extract the vehicle registration mark.

A “vehicle registration mark” (VRM) or “vehicle registration number” refers a unique string of characters, for example alphanumeric characters, used to recognise a vehicle, found on the vehicle registration plate.

A vehicle registration list, access list, whitelist, or blacklist, refers to one or more lists and/or databases that contain one or more vehicle registration numbers. The vehicle registration list may be used to match a known vehicle registration number from the list to a vehicle registration number to be recognised.

A first aspect of the present invention comprises a computer-implemented method for vehicle registration number recognition, the method comprising: obtaining a vehicle registration number to be recognised, comprising a plurality of characters; obtaining a plurality of authorised vehicle registration numbers; and comparing the vehicle registration number to be recognised with the plurality of authorised vehicle registration numbers. Comparing the vehicle registration number to be recognised with the plurality of authorised vehicle registration numbers comprises identifying the number of characters in common between the vehicle registration number to be recognised and each of the plurality of authorised vehicle registration numbers, and determining whether the number of characters in common between the vehicle registration number to be recognised and each authorised vehicle registration number is equal to and/or above a pre-determined threshold. In the event that the number of characters in common between the vehicle registration number to be recognised and at least one authorised vehicle registration number is above the pre-determined threshold, a signal is sent indicating that the vehicle registration number is recognised. This may be advantageous as it reduces the number of false-negative results produced by current registration number recognition systems which require exact registration number matches. This reduces the number of vehicles which are incorrectly identified, for example due to an ANPR camera mis-read or incorrect data in the plurality of authorised vehicle registration numbers.

In some examples, the pre-determined threshold is based on the number of characters in the vehicle registration number to be recognised. In some examples, the pre-determined threshold may be all characters of the vehicle registration number to be recognised minus one (“VRM-1”). In some examples, the pre-determined threshold may be all characters of the vehicle registration number to be recognised minus two (“VRM-2”). As above, this may be advantageous as it reduces the number of false-negative results produced by current registration number recognition systems which require exact registration number matches. In some examples, VRM-1 may be preferred to compromise between reducing the number of false-negative results, whilst limiting the number of false-positive results.

In some examples, the pre-determined threshold may comprise a pre-determined range, for example wherein the method is configured to determine whether the number of characters in common between the vehicle registration number to be recognised and each authorised vehicle registration number is within a pre-determined range. In some examples, determining whether the number of characters in common between the vehicle registration number to be recognised and each authorised vehicle registration number is above a pre-determined threshold comprises determining whether the number of characters in common is equal to and/or above a pre-determined threshold but less than all characters. For example, wherein the method comprises a pre-determined range, wherein the characters in common may be equal to and/or above a pre-determined threshold of characters but less than all characters, such that the signal that the vehicle registration number is recognised is sent in the event that the number of characters in common between the vehicle registration number to be recognised and at least one authorised vehicle registration number is equal to and/or above the pre-determined threshold but less than all characters. In some examples, the predetermined range may comprise a single value, for example wherein the predetermined threshold may be all characters of the vehicle registration number to be recognised minus one (“VRM-1”), thus to fulfil the criteria wherein the number of characters in common between the vehicle registration number to be recognised and at least one authorised vehicle registration number is equal to and/or above the pre-determined threshold but less than all characters, the number of common characters must be equal to all characters of the vehicle registration number to be recognised minus one (“VRM-1”).

In some examples, comparing the vehicle registration number to be recognised with the plurality of authorised vehicle registration numbers further comprises determining whether the common characters of the vehicle registration number to be recognised and the at least one authorised vehicle registration number are in the same relative position.

Determining whether the common characters are in the same relative position may comprise determining whether the common characters are in the same sequence within the string of characters. For example, purely for illustrative purposes, comparing the vehicle registration number “AB12 CDE” to authorised vehicle registration number “AB12 ODE” comprises determining whether the common characters, in this case A, B, 1, 2, D, and E, are in the same relative position or sequence within the string of characters. In this example, the common characters are in the same relative position and sequence. However, purely for illustrative purposes, comparing vehicle registration number “AB12 CDE” to authorised vehicle registration number “BA12 ODE”, the common characters, also A, B, 1, 2, D, and E, are not in the same relative position or sequence within the string of characters as characters A and B are in different relative positions and sequence. In the event that the common characters are in the same relative position in the vehicle registration number to be recognised and the at least one authorised vehicle registration number, the method is then configured to send the signal that the vehicle registration number is recognised.

In some examples, comparing the vehicle registration number to be recognised with the plurality of authorised vehicle registration numbers further comprises identifying at least one authorised vehicle registration number wherein the at least one authorised vehicle registration number comprises (i) the same number of characters as the vehicle registration number to be recognised, and (ii) the same characters as the vehicle registration number to be recognised (i.e. all characters are common to both the vehicle registration number to be recognised and the at least one authorised vehicle registration number); and determining the relative position/sequence of the characters of the vehicle registration number to be recognised and the characters of the at least one vehicle registration number. In the event that (i) at least two characters are in the incorrect relative position or sequence, and (ii) the at least two incorrectly positioned characters are adjacent, the method is configured to send the signal that the vehicle registration number is recognised. In some examples, at least two characters being in the incorrect relative position or sequence comprises all the characters minus two being in the same relative position. For example, purely for illustrative purposes, comparing the vehicle registration number “AB12 CDE” to authorised vehicle registration number “BA12 CDE” comprises determining that all characters minus two are in the same relative position or sequence within the string of characters of the vehicle registration number, and the two incorrect characters, in this case B and A, are adjacent. Thus, in this example, a signal would be sent indicating that the vehicle registration number had been recognised. However, purely for illustrative purposes, comparing vehicle registration number “AB12 CDE” to authorised vehicle registration number “AC12 BDE”, whilst all characters minus two are in the same relative position or sequence within the string of characters of the vehicle registration number, the method would determine that the two incorrect characters, in this case B and C, are not adjacent; thus, the vehicle registration number would not be recognised based on this example vehicle registration number. This method may be advantageous to reduce false-negative vehicle registration number recognition where the data associated with the plurality of authorised vehicle registration numbers has been incorrectly inputted, for example by typographical error.

In some examples, obtaining the plurality of authorised vehicle registration numbers comprises obtaining a list or database comprising the plurality of authorised vehicle registration numbers, for example a vehicle registration list. The list or database may be obtained and/or stored locally or obtained from a remote server.

The method may further comprise obtaining an image comprising the vehicle registration number to be recognised and the corresponding vehicle. Optionally, the method may be configured to obtain at least one indication of a property of the vehicle by image recognition, based on the image of the vehicle. In some examples, using image recognition to identify at least one indication of a property of the vehicle may comprise using at least one of image classification, object detection, image segmentation, for example using artificial intelligence (AI). In some examples, the indication of a property of the vehicle may include, but is not limited to, at least one of vehicle type, make, model, and colour. In the event that the vehicle registration number is recognised based any of the example methods set out above, the method further comprises comparing the at least one indication of the property of the vehicle from the image to at least one obtained indication of the same property of the vehicle corresponding to the authorised vehicle registration number. The at least one indication of a property of the vehicle corresponding to the at least one authorised vehicle registration number may be obtained from the list or database comprising the plurality of authorised vehicle registration numbers, or a separate list or database. In some examples, the indication of the property of the vehicle may be obtained from an official database based on the authorised vehicle registration number, for example the Driver and Vehicle Licensing Agency (DVLA) or other equivalent national database or register. In the event that the at least one indication of the property of the vehicle from the image and the at least one obtained indication of the property of the vehicle corresponding to the authorised vehicle registration number are the same, the method may be further configured to send the signal that the vehicle registration number and/or vehicle is recognised. This may be advantageous to reduce the number of false-positive vehicle registration number recognitions, as at least one property of the vehicle is cross-checked according to the vehicle registration number. For example, purely for illustrative purposes, taking the example discussed above the vehicle registration number “AB12 CDE” may be considered to be recognised as authorised vehicle registration number “AB12 ODE” based on the method described above wherein the vehicle registration number comprises VRM-1 common characters and the common characters are in the same relative position or sequence. However, according to this example, if image recognition identified the vehicle of “AB12 CDE” to be a red car, whereas the obtained indications of the same properties indicated that the vehicle corresponding to the authorised vehicle registration number “AB12 ODE” was a blue van, the method may deny, reject, or override the decision to recognise the vehicle registration number based on the similar sequence of characters. This may be advantageous to reduce the number of false-positive vehicle registration number recognitions, as at least one property of the vehicle is cross-checked according to the vehicle registration number. However, purely for illustrative purposes, if the obtained properties indicated that the vehicle corresponding to the authorised vehicle registration number “AB12 ODE” was also a red car, the method may be configured to send the signal that the vehicle registration number and/or vehicle is recognised.

In some examples, the method further comprises sending an alert to an administrator. The alert may comprise an indication that a vehicle or vehicle registration number was recognised despite being a non-identical match to the plurality of authorised vehicle registration numbers, for example including the actual vehicle registration number and the authorised vehicle registration number it was considered to be recognised against, optionally the alert may further comprise an image of the vehicle. In some examples, sending the alert further comprises sending a signal to update the list or database of authorised vehicle registration numbers with the recognised vehicle registration number. This may be advantageous to correct errors in the list or database of authorised vehicles, for example in the case where the authorised vehicle registration number considered contains a typographical or other input error. Preferably, the signal to update the list or database may be sent in the event that the vehicle registration number is recognised and at least one indication of the property of the vehicle from the image and the at least one obtained indication of the property of the vehicle corresponding to the authorised vehicle registration number are the same, for example wherein the indication of the property of the authorised vehicle may be obtained from the DVLA database, or similar. This may be advantageous to prevent correct authorised vehicle registration data being overwritten.

In some examples, the method of the present invention described above may be used across all scenarios where ANPR may be employed. For example, the method may be used to identify stolen or missing vehicles, wherein the vehicle registration numbers of relevant vehicles are obtained as the plurality of authorised vehicle registration numbers. In the event that a vehicle registration number is recognised in comparison to the list of relevant vehicle registration numbers as detailed by the method of the present invention, for example by a ANPR camera or other suitable image capturing means, a signal is sent to alert the authorities, for example including the last seen location of the vehicle/location of the ANPR camera or image capturing means to help the vehicle be recovered. This may be particularly helpful to detect stolen vehicles where the vehicle registration plate has been illegally modified to disguise the stolen plate, for example where a “0” is illegally modified into an “8”. Supplementary information about the vehicle may also be cross-checked using image recognition, for example based on image recognition, as discussed above.

Another example application of the present method is to permit access to recognised vehicles to a restricted area, for example controlled by virtual or physical barriers. In some examples, sending the signal that the vehicle registration number and/or vehicle is recognised comprises sending a signal to permit access of the corresponding vehicle to a restricted area. In some examples, for example for virtual barriers, the method may also be configured for the inverse, for example in the event that the vehicle registration number is not recognised, sending a signal to prevent access or register a traffic offence, for example issuing a fine to the trespassing vehicle registration number.

In some examples, sending the signal to permit access of the vehicle to the restricted area comprises sending a signal to displace or remove a road barrier. For example, signal may be sent to a barrier control unit to displace or remove a barrier, for example wherein the road barrier may comprise, but is not limited to a barrier, gate, or bollard, for example a rising bollard.

In some examples, sending the signal to permit access of the vehicle comprises repeating the signal after a pre-determined time interval until the vehicle is granted access to the restricted area, for example, by removing or displacing a road barrier. In some examples, the signal may be repeated every 5 seconds, however the skilled person will understand that other time interval or frequency of repeated signals may be employed. In some examples, the signal is only repeated whilst vehicle still detected, for example by a camera or other suitable image capturing means.

In some examples, the method further comprises obtaining an image comprising the vehicle registration number and the corresponding vehicle and assigning the vehicle to a vehicle category from a plurality of vehicle categories, based on image recognition of the vehicle. The method may then comprise determining whether the vehicle is permitted to access the restricted area based on the assigned vehicle category, wherein a subset of the vehicle categories are permitted. In the event that the vehicle is permitted based on the assigned vehicle type, the method comprises sending the signal to permit access of the vehicle to a restricted area. Vehicle categories may include, but are not limited to, emergency vehicle, bus or other public transport vehicle, delivery vehicle, private vehicle, or other. In some examples, a subset of vehicle categories are permitted regardless of the vehicle registration number. For example, in some examples at least one of emergency vehicles, public transport vehicles, for example buses, and/or delivery vehicles, may be permitted access to the restricted area regardless of whether their vehicle registration number is recognised in comparison to the plurality of authorised registration vehicles. In some examples, using image recognition to identify at least one indication of a property of the vehicle may comprise using at least one of image classification, object detection, image segmentation, for example using AI. Optionally, at least one property of vehicle may also be identified and verified by comparison to a list or database comprising vehicle types and vehicle registration numbers, such as the DVLA database or equivalent official register.

In some examples, obtaining the vehicle registration number to be recognised comprises obtaining an image comprising the vehicle registration number and identifying the characters of the vehicle registration number. Identifying the characters of the vehicle registration number may comprise at least one of (i) extracting and (ii) parsing the characters in the image into a sequence of characters representing the vehicle registration number. Alternatively, obtaining the vehicle registration number to be recognised may comprise directly obtaining the sequence of characters of the vehicle registration number.

In a second aspect of the invention there is provided a computer-implemented method for vehicle registration number recognition, the method comprising obtaining a vehicle registration number to be recognised, comprising a plurality of characters; obtaining a plurality of authorised vehicle registration numbers; and identifying at least one authorised vehicle registration number from the plurality of authorised vehicle registration numbers, wherein the at least one authorised vehicle registration comprises (i) the same number of characters as the vehicle registration number to be recognised, and (ii) the same characters as the vehicle registration number to be recognised (i.e. all characters are common to both the vehicle registration number to be recognised and the at least one authorised vehicle registration number). The method further comprises determining the relative position or sequence of the characters of the vehicle registration number to be recognised and the characters of the identified authorised vehicle registration number and identifying any of the authorised vehicle registration comprising (i) the same number of characters as the vehicle registration number to be recognised, (ii) the same characters as the vehicle registration number to be recognised, (iii) at least two characters not in the same position or sequence as the vehicle registration number to be recognised, and (iv) the incorrect at least two characters are adjacent, sending a signal that the vehicle registration number is recognised. In the event that conditions (i) to (iv) are fulfilled, the method is configured to send the signal that the vehicle registration number is recognised. In some examples, at least two characters being in the incorrect relative position or sequence comprises all the characters minus two being in the same relative position. This method may be advantageous to reduce false-negative vehicle registration number recognition where the data associated with the plurality of authorised vehicle registration numbers has been incorrectly inputted, for example by typographical error.

In some examples, the method further comprises obtaining an image comprising the vehicle registration number to be recognised and the corresponding vehicle; obtaining at least one indication of a property of the vehicle, based on image recognition of the image of the vehicle; and comparing the indication of the property of the vehicle from the image and an obtained indication of the corresponding property of the vehicle corresponding to the authorised vehicle registration number comprising (i) the same number of characters as the vehicle registration number to be recognised, (ii) the same characters as the vehicle registration number to be recognised, (iii) at least two characters not in the same position or sequence as the vehicle registration number to be recognised, and (iv) the incorrect at least two characters are adjacent, sending a signal that the vehicle registration number is recognised. In the event that the at least one indication of the property of the vehicle from the image and the at least one obtained indication of the property of the vehicle corresponding to the authorised vehicle registration number are the same, sending the signal that the vehicle registration number and/or vehicle is recognised. The indication of a property of the vehicle may include, but is not limited to, at least one of vehicle type, make, model, and colour.

In some examples, obtaining the plurality of authorised vehicle registration numbers further comprises obtaining at least one indication of a property of a vehicle corresponding to each authorised vehicle registration number, for example wherein the authorised vehicle registration numbers and at least one indication of a property of each corresponding vehicle are obtained a list or database, for example a vehicle registration list. Alternatively, the at least one indication of a property of the vehicle corresponding to the at least one authorised vehicle registration number may be obtained from a separate list or database. In some examples, the indication of the property of the vehicle may be obtained from an official database based on the authorised vehicle registration number, for example the Driver and Vehicle Licensing Agency (DVLA) or other equivalent national database or register.

In some examples, sending the signal that the vehicle registration number and/or vehicle is recognised comprises sending a signal to permit access of the corresponding vehicle to a restricted area. In some examples, for example for virtual barriers, the method may also be configured for the inverse, for example in the event that the vehicle registration number is not recognised, sending a signal to prevent access or register a traffic offence, for example issuing a fine to the trespassing vehicle registration number.

In some examples, sending the signal to permit access of the vehicle to the restricted area comprises sending a signal to displace or remove a road barrier. For example, signal may be sent to a barrier control unit to displace or remove a barrier, for example wherein the road barrier may comprise, but is not limited to a barrier, gate, or bollard, for example a rising bollard.

In some examples, sending the signal to permit access of the vehicle comprises repeating the signal after a pre-determined time interval until the vehicle is granted access to the restricted area, for example, by removing or displacing a road barrier. In some examples, the signal may be repeated every 5 seconds, however the skilled person will understand that other time interval or frequency of repeated signals may be employed. In some examples, the signal is only repeated whilst vehicle still detected, for example by a camera or other suitable image capturing means.

In some examples, the method further comprises sending an alert to an administrator. The alert may comprise an indication that a vehicle or vehicle registration number was recognised despite being a non-identical match to the plurality of authorised vehicle registration numbers, for example wherein the alert may include the actual vehicle registration number and the authorised vehicle registration number it was considered to be recognised against, optionally the alert may further comprise an image of the vehicle. In some examples, sending the alert further comprises sending a signal to update the list or database of authorised vehicle registration numbers with the recognised vehicle registration number. This may be advantageous to correct errors in the list or database of authorised vehicles, for example in the case where the authorised vehicle registration number considered contains a typographical or other input error. Optionally, the signal to update the list or database may be sent in the event that the vehicle registration number is recognised and at least one indication of the property of the vehicle from the image and the at least one obtained indication of the property of the vehicle corresponding to the authorised vehicle registration number are the same, for example wherein the indication of the property of the authorised vehicle may be obtained from the DVLA database, or similar. This may be advantageous to prevent correct authorised vehicle registration data being overwritten by cross checking at least one property of the vehicle to be recognised and the vehicle corresponding to an authorised vehicle registration number.

In a third aspect of the present invention there is provided a computer-implemented method for permitting vehicle access to a restricted area comprising: obtaining an image comprising a vehicle; assigning the vehicle to a vehicle category from a plurality of vehicle categories, based on the image of the vehicle; determining whether the vehicle is permitted to the restricted area, based on the assigned vehicle category, wherein a subset of the vehicle categories are permitted to the restricted area; and in the event that the vehicle is determined to be permitted based on the assigned vehicle category, sending a signal to permit access of the vehicle to a restricted area. Vehicle categories may include, but are not limited to, emergency vehicles, buses or other public transport vehicles, delivery vehicles, private vehicles, or other. For example, in some examples at least one of emergency vehicles, public transport vehicles, for example buses, and/or delivery vehicles, may be permitted access to the restricted, whereas private vehicles are not permitted based on solely the assigned category. In some examples, assigning the vehicle to a vehicle category from a plurality of vehicle categories, based on the image of the vehicle comprises using image recognition, for example using AI. In some examples, using image recognition may comprise using at least one of image classification, object detection, image segmentation, or other suitable method, for example using AI.

In some examples, the image comprising the vehicle further comprises a vehicle registration number corresponding to the vehicle; and the method further comprises identifying the number of characters in common between the vehicle registration number to be recognised and each of a plurality of authorised vehicle registration numbers; determining whether the number of characters in common between the vehicle registration number to be recognised and each authorised vehicle registration number is above a pre-determined threshold; and in the event that the number of characters in common between the vehicle registration number to be recognised and at least one authorised vehicle registration number is above the pre-determined threshold, sending a signal to permit access of the vehicle to a restricted area. In some examples, the pre-determined threshold is based on the assigned vehicle category. In some examples, a subset of the vehicle categories are permitted to the restricted area regardless of whether the vehicle registration number is recognised.

In some examples, the plurality of authorised vehicle registration numbers may be obtained from a list or database comprising the plurality of authorised vehicle registration numbers, for example a vehicle registration list. The plurality of authorised vehicle registration numbers may be obtained locally or from a remote server.

In some examples, sending the signal to permit access of a vehicle comprises sending a signal to a processor to displace a physical barrier. For example, where the physical barrier may be a road barrier, such as, but not limited to a bollard, barrier, or gate.

In some examples, in the event that the vehicle is permitted, the method further comprises sending an alert to an administrator. The alert may comprise an indication that a vehicle or vehicle registration number was permitted, for example with either based on the assigned vehicle category or as a result of vehicle registration number recognition despite being a non-identical match to the plurality of authorised vehicle registration numbers, optionally the alert may further comprise an image of the vehicle. In the case that the vehicle was admitted based on vehicle registration number recognition, the alert may comprise the actual vehicle registration number and the authorised vehicle registration number it was considered to be recognised against. In some examples, sending the alert further comprises sending a signal to update the list or database of authorised vehicle registration numbers with the recognised vehicle registration number. This may be advantageous to correct errors in the list or database of authorised vehicles, for example in the case where the authorised vehicle registration number considered contains a typographical or other input error, and/or add vehicle registration numbers for vehicles permitted based on their assigned vehicle type. In some examples, vehicle registration numbers for vehicles permitted based on their assigned vehicle type may be added to the plurality of authorised vehicle registration numbers for a pre-determined time period, after which the vehicle registration number may be removed from the plurality of authorised vehicle registration numbers. Optionally, the signal to update the list or database may be sent in the event that the vehicle registration number is recognised and at least one indication of the property of the vehicle from the image and at least one obtained indication of the property of the vehicle corresponding to the authorised vehicle registration number are the same, for example wherein the indication of the property of the authorised vehicle may be obtained from the DVLA database, or similar. This may be advantageous to prevent correct authorised vehicle registration data being overwritten by cross checking at least one property of the vehicle to be recognised and the vehicle corresponding to an authorised vehicle registration number.

In a fourth aspect of the present invention, there is provided a computer-implemented method for vehicle registration number recognition, the method comprising obtaining a vehicle registration number to be recognised, comprising a plurality of characters; sending a request to a server to identify the number of characters in common between the vehicle registration number to be recognised and each of the plurality of authorised vehicle registration numbers; sending a request to a server to determine whether the number of characters in common between the vehicle registration number to be recognised and each of the plurality of authorised vehicle registration numbers is above a pre-determined threshold but less than all characters; receiving an indication that the number of characters in common between the vehicle registration number to be recognised and at least one authorised vehicle registration number is above a pre-determined threshold but less than all characters; sending a signal that the vehicle registration number is recognised. This method may be advantageous as it reduces the number of false-negative results produced by current registration number recognition systems which require exact registration number matches. This reduces the number of vehicles which are incorrectly identified, for example due to an ANPR camera mis-read or incorrect data in the plurality of authorised vehicle registration numbers.

In some examples, the server may be a remote server. For example, the remote server may be, but is not limited to, a cloud provider or an edge device. By sending requests to a server, the method may be performed on or by device with reduced computing/processing power, for example a simple ANPR camera or other suitable image capturing means, reducing cost. The server may be configured to receive and execute requests from multiple devices.

In some examples, the pre-determined threshold is based on the number of characters in the vehicle registration number to be recognised. In some examples, the pre-determined threshold may be all characters of the vehicle registration number to be recognised minus one (VRM-1). In some examples, the pre-determined threshold may be all characters of the vehicle registration number to be recognised minus two (VRM-2). As above, this may be advantageous as it reduces the number of false-negative results produced by current registration number recognition systems which require exact registration number matches. In some examples, VRM-1 may be preferred to compromise between reducing the number of false-negative results, whilst limiting the number of false-positive results.

In some examples, the pre-determined threshold may comprise a pre-determined range, for example wherein the method is configured to determine whether the number of characters in common between the vehicle registration number to be recognised and each authorised vehicle registration number is within a pre-determined range. In some examples, determining whether the number of characters in common between the vehicle registration number to be recognised and each authorised vehicle registration number is above a pre-determined threshold comprises determining whether the number of characters in common is equal to and/or above a pre-determined threshold but less than all characters. For example, wherein the method comprises a pre-determined rang, wherein the characters in common may be equal to and/or above a pre-determined threshold of characters but less than all characters, such that the signal that the vehicle registration number is recognised is sent in the event that the number of characters in common between the vehicle registration number to be recognised and at least one authorised vehicle registration number is equal to and/or above the pre-determined threshold but less than all characters. In some examples, the predetermined range may comprise a single value, for example wherein the predetermined threshold may be all characters of the vehicle registration number to be recognised minus one (VRM-1), thus to fulfil the criteria wherein the number of characters in common between the vehicle registration number to be recognised and at least one authorised vehicle registration number is equal to and/or above the pre-determined threshold but less than all characters, the number of common characters must be equal to all characters of the vehicle registration number to be recognised minus one (VRM-1).

In some examples, the method further comprises sending a request to the server to determine whether the common characters of the vehicle registration number to be recognised and the at least one authorised vehicle registration number are in the same relative position; receiving an indication that the common characters of the vehicle registration number to be recognised and the at least one authorised vehicle registration number are in the same relative position or sequence; and sending the signal that the vehicle registration number is recognised in response to receiving the indications that (i) the number of characters in common between the vehicle registration number to be recognised and at least one authorised vehicle registration number is above a pre-determined threshold but less than all characters and (ii) the common characters of the vehicle registration number to be recognised and the at least one authorised vehicle registration number are in the same relative position or sequence.

In some examples, the method further comprises sending a request to the server to identify at least one authorised vehicle registration number wherein the at least one authorised vehicle registration number comprises (i) the same number of characters as the vehicle registration number to be recognised, and (ii) the same characters as the vehicle registration number to be recognised; sending a request to the server to identify whether the at least one authorised vehicle registration number comprises (i) at least two characters not the same relative position compared to the vehicle registration number to be recognised, and (ii) the at least two incorrectly positioned characters are adjacent; receiving an indication that at least one authorised vehicle registration number comprises (i) the same number of characters as the vehicle registration number to be recognised, (ii) the same characters as the vehicle registration number to be recognised, (iii) at least two characters not the same relative position compared to the vehicle registration number to be recognised, and (iv) the at least two incorrectly positioned characters are adjacent; sending a signal that the vehicle registration number is recognised in response to receiving the indication that at least one authorised vehicle registration number comprises (i) the same number of characters as the vehicle registration number to be recognised, (ii) the same characters as the vehicle registration number to be recognised, (iii) at least two characters not the same relative position compared to the vehicle registration number to be recognised, and (iv) the at least two incorrectly positioned characters are adjacent. This method may be advantageous to reduce false-negative vehicle registration number recognition where the data associated with the plurality of authorised vehicle registration numbers has been incorrectly inputted, for example by typographical error.

In a fifth aspect of the invention, there is provided a computer program product comprising instructions configured to program a programmable device to perform the method of any of the methods of the first to fourth aspects of the present invention.

In a sixth aspect of the invention, there is provided an automatic number plate recognition camera comprising a processor configured to perform the method of any of the methods of the first to fourth aspects of the present invention.

### DRAWINGS

Embodiments of the disclosure will now be described, by way of example only, with reference to the accompanying drawings, in which:

FIG. 1A shows a flow-chart illustrating an example computer-implemented method for vehicle registration number recognition. FIG. 1B shows an example method for vehicle registration number recognition, for example the method of FIG. 1A, comprising additional steps. FIG. 1C shows an example method for vehicle registration number recognition, for example the method of FIG. 1A, wherein the method is configured to send processing requests to a remote server.

FIG. 2 shows a flow-chart illustrating another example computer-implemented method for vehicle registration number recognition.

FIG. 3 shows a flow-chart illustrating an example method for permitting vehicle access to a restricted area. In some examples, the method of FIG. 3 may be used in combination with the methods of FIGS. 1 to 2.

FIG. 4 shows an example graphical interface, presenting information generated by the method, for example the method of any of FIGS. 1 to 3.

FIGS. 5A and 5B show example graphical interfaces, for example the graphical user interface of FIG. 4, presenting information generated by the method, for example the method of any of FIGS. 1 to 3.

FIG. 6 shows an example alert generated by the method, for example the method of any of FIGS. 1 to 2.

FIG. 7 shows an example system for use with the method of FIGS. 1 to 6, comprising an ANPR camera and barrier control unit, wherein vehicle registration number recognition method, for example any of the methods of FIGS. 1 to 2, is performed locally at the ANPR camera.

FIG. 8 shows an example system for use with the method of FIGS. 1 to 6, comprising an ANPR camera and barrier control unit, wherein vehicle registration number recognition method, for example any of the methods of FIGS. 1 to 2, is performed locally at the barrier control unit.

FIG. 9 shows an example system for use with the method of FIGS. 1 to 6, comprising an ANPR camera, barrier control unit, and a remote server, wherein vehicle registration number recognition method, for example any of the methods of FIGS. 1 to 2, is performed by the remote server.

FIGS. 10 and 11 show example systems for use with the method of FIGS. 1 to 6, comprising an ANPR camera, barrier control unit, and a remote server, wherein vehicle registration number recognition method, for example any of the methods of FIGS. 1 to 3, is performed by a processor at the barrier control unit.

### SPECIFIC DESCRIPTION

Embodiments of the claims relate to methods, devices, and systems for vehicle registration number recognition.

It will be appreciated from the discussion above that the embodiments shown in the Figures are merely exemplary, and include features which may be generalised, removed replaced, or added in combination, as described herein and as set out in the claims.

The steps, connections, and processing of information and signals illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other examples and figures, unless this disables the embodiment or a sequence is explicitly or implicitly required (e.g., for a sequence of read the value and process said read value, the value must be obtained prior to processing it, although some of the associated processing may be performed prior to, concurrently with, and/or after the read operation).

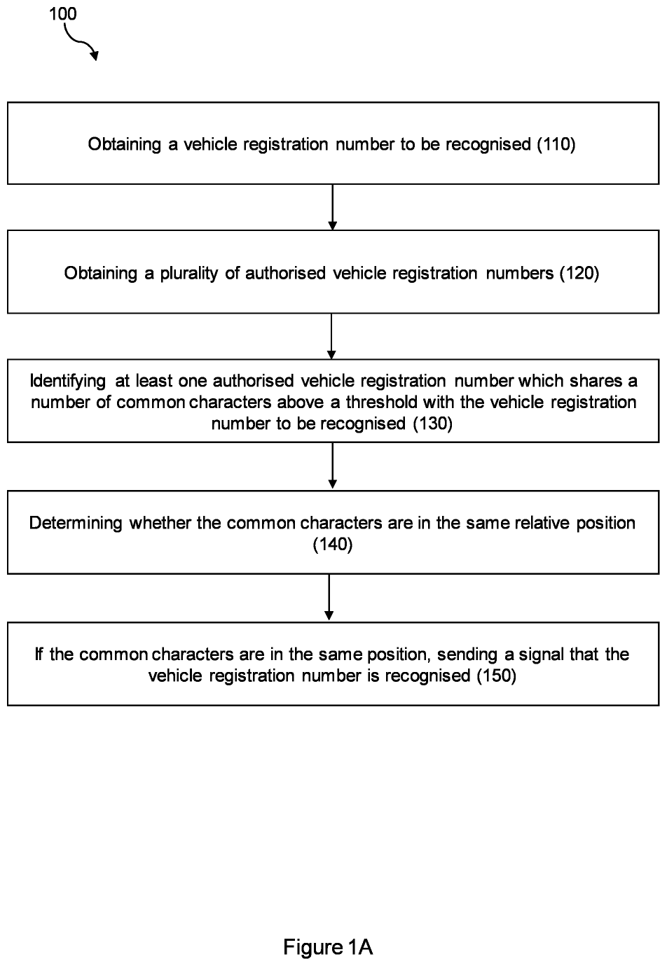

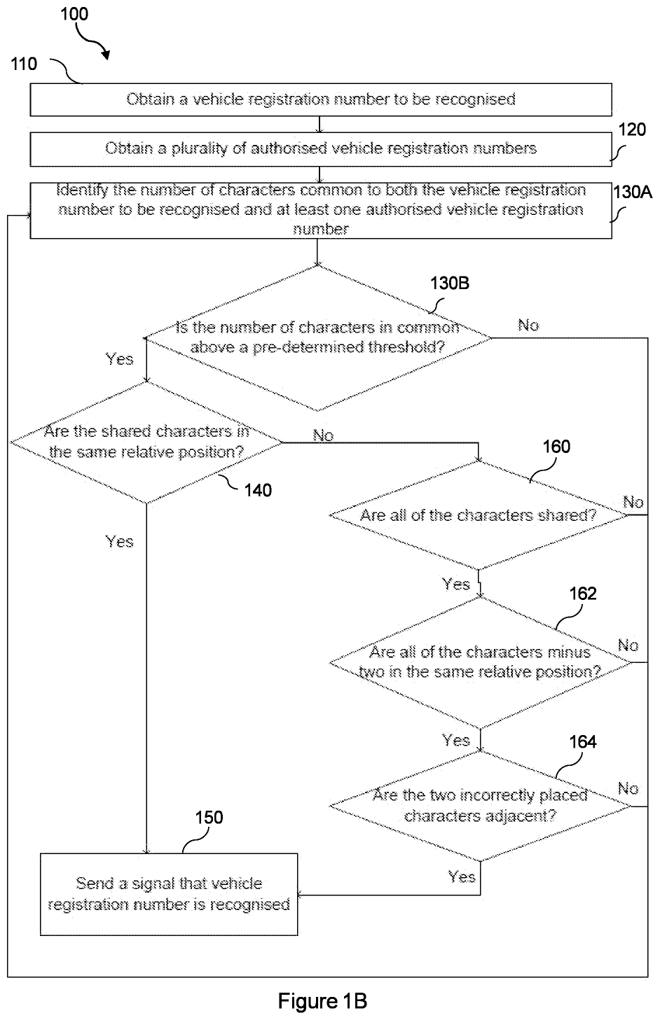

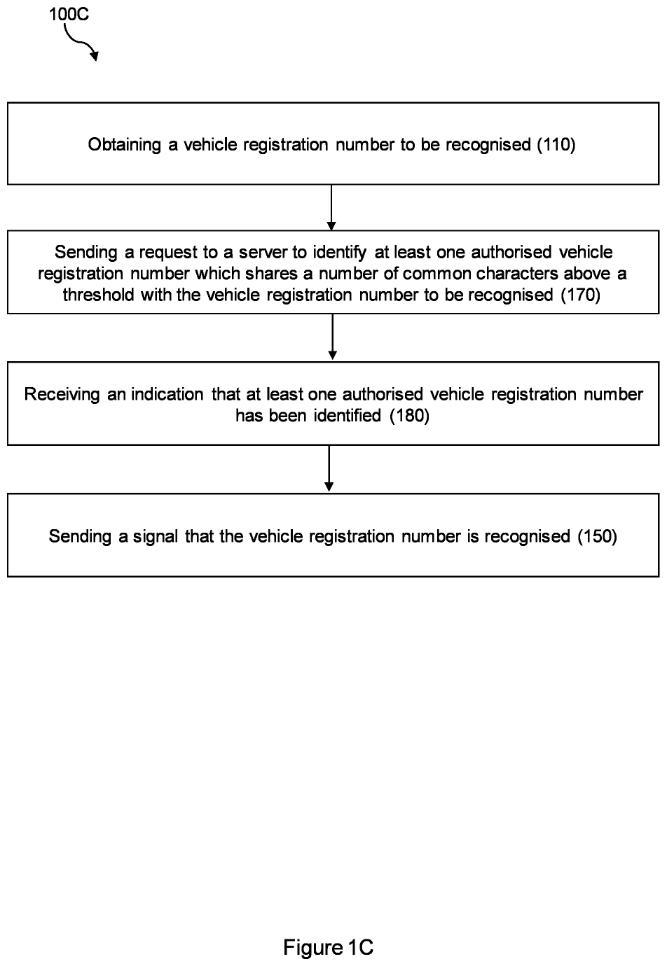

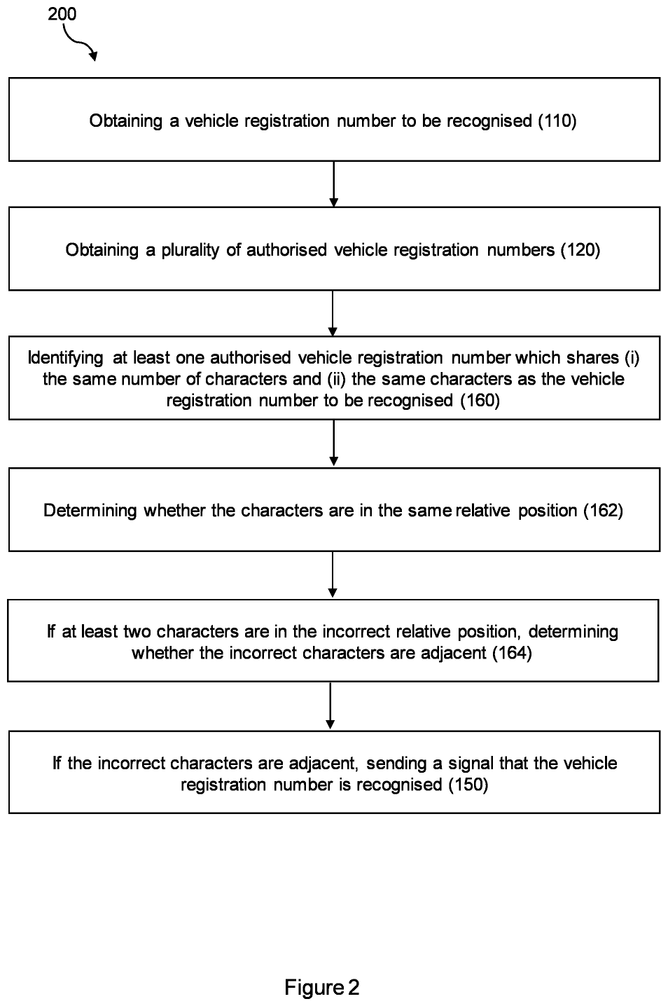

FIGS. 1A to 2 illustrate example methods for vehicle registration number recognition. These methods may be configured to be performed by processor, for example a processor in an ANPR camera or other suitable image capturing device, in a barrier control unit, or in a separate processor unit, for example wherein the processor unit may be, an edge device, a remote device, such as a cloud-based remote server, or local to an ANPR camera and/or barrier system.

First considering the method of FIG. 1A, the method 100 comprises obtaining a vehicle registration number to be recognised 110. Obtaining a vehicle registration number may comprise (i) obtaining a sequence of characters, wherein the sequence of characters represent the vehicle registration number, or (ii) obtaining an image of a vehicle registration plate, wherein the method may comprise extracting and parsing the vehicle registration number from the image of the vehicle registration plate.

Secondly, the method comprises obtaining a plurality of authorised vehicle registration numbers 120. Obtaining the plurality of authorised vehicle registration numbers 120 may comprise obtaining a vehicle registration list, wherein the list comprises the plurality of authorised vehicle registration numbers. The plurality of authorised vehicle registration numbers may be obtained from a local memory, or from a remote server.

The method then comprises identifying at least one authorised vehicle registration number which shares a number of common characters above a threshold with the vehicle registration number to be recognised 130. This may comprise two sub-stages: (i) identifying the number of common characters between at least one authorised registration number and the vehicle registration number to be recognised; and (ii) determining whether the number of common characters is above a pre-determined threshold. In some examples, the pre-determined threshold is dependent on the number of characters in the number plate to be recognised, for example wherein the pre-determined threshold for the number of common characters may be the total number of characters of the vehicle registration number to be recognised minus an integer, for example minus one (i.e., VRM-1). In some examples, the method is configured to identify at least one authorised vehicle registration number which shares a number of common characters above a threshold with the vehicle registration number to be recognised but has fewer than all characters in common.

The method of FIG. 1A then comprises determining whether the common characters are in the same relative position in both the vehicle registration number to be recognised and the selected authorised vehicle registration number 140, or in other words, determining whether the common characters are in the same sequence.

If the common characters are in the same position, the method further comprises sending a signal that the vehicle registration number is recognised 150. In some examples, where the method may be implemented in applications to control vehicular access to restricted area, sending the signal that the vehicle registration number is recognised 150 may further comprise sending a signal to permit access of the vehicle to the restricted area. For example, in the case of a physical barrier system, sending the signal to permit access of the vehicle to the restricted area may comprise sending a signal to displace or remove the physical barrier.

In some examples, the steps of the method may be performed simultaneously for the plurality of authorised vehicle registration numbers, for example identifying the number of characters in common for each authorised vehicle and progressing a selection of the plurality of vehicle registration numbers that fulfil the criteria to the next step of the method. Alternatively, in some examples, the steps of the method may be performed iteratively for each of the authorised vehicle registration numbers, repeating the method for each of the authorised vehicle registration numbers whilst cycling through the plurality of vehicle registration numbers.

FIG. 1B shows a flow-chart of the example method 100 of FIG. 1A, comprising additional steps 160, 162, and 164. In this example, in the event that the method fails to identify at least one authorised vehicle registration number comprising a number of common characters above the threshold wherein the common characters are not in the same relative position or sequence 140, the method further comprises determining whether all the characters are common between the at least one authorised vehicle registration number and the vehicle registration number to be recognised 160. If all characters are common to both, the method further comprises determining whether all of the characters minus two are in the same relative position or sequence 162, or in other words, two characters are in different positions or in a different sequence. If this is so, the method then further comprises identifying whether the two incorrectly placed characters are adjacent 164. In this case, the method is configured to send the signal that the vehicle registration number is recognised 150.

FIG. 1B shows that the steps of the method may be performed iteratively for at least one authorised vehicle registration number, repeating the method for each of the authorised vehicle registration numbers whilst cycling through the plurality of vehicle registration numbers. However, the skilled person will understand that the steps of the method may also be performed simultaneously for the plurality of authorised vehicle registration numbers, for example identifying the number of characters in common for each authorised vehicle and progressing a selection of the plurality of vehicle registration numbers that fulfil the criteria to the next step of the method.

FIG. 1C shows an example method 100C for vehicle registration number recognition. Firstly, the method 100C comprises obtaining a vehicle registration number to be recognised. As for the method of FIGS. 1A and 1B, obtaining a vehicle registration number may comprise (i) obtaining a sequence of characters, wherein the sequence of characters represent the vehicle registration number, or (ii) obtaining an image of a vehicle registration plate, wherein the method may comprise extracting and parsing the vehicle registration number from the image of the vehicle registration plate.

The method 100C then further comprises sending a request to a server to identify at least one authorised vehicle registration number which shares a number of common characters above a threshold with the vehicle registration number to be recognised 170. By sending requests to a server, instead of directly performing the processing steps for example as in FIGS. 1A and 1B, the method may be performed on a device with reduced computing/processing power. The server may also store the plurality of authorised vehicle registration numbers, thereby also reducing the memory capacity required to perform the method.

The skilled person will also understand that in some examples the method of FIG. 1C may further comprise sending at least one request to the server to identify at least one authorised vehicle registration based on the method steps of 160, 162, and 164 of FIG. 1B.

Upon receiving an indication from the server that at least one authorised vehicle registration number has been identified 180, the method further comprises sending a signal that the vehicle registration number is recognised 150. As with the methods of FIGS. 1A and 1B, in some examples, the method may be implemented in applications to control vehicular access to restricted area, wherein sending the signal that the vehicle registration number is recognised 150 may further comprise sending a signal to permit access of the vehicle to the restricted area. For example, in the case of a physical barrier system, sending the signal to permit access of the vehicle to the restricted area may comprise sending a signal to displace or remove the physical barrier.

FIG. 2 shows an example method 200 for vehicle registration number recognition. Firstly, the method comprises obtaining a vehicle registration number to be recognised 110. As for the method of FIGS. 1A to 1C, obtaining a vehicle registration number may comprise (i) obtaining a sequence of characters, wherein the sequence of characters represent the vehicle registration number, or (ii) obtaining an image of a vehicle registration plate, wherein the method may comprise extracting and parsing the vehicle registration number from the image of the vehicle registration plate.

The method further comprises obtaining a plurality of authorised vehicle registration numbers 120. Obtaining the plurality of authorised vehicle registration numbers 120 may comprise obtaining a vehicle registration list, wherein the list comprises the plurality of authorised vehicle registration numbers. The plurality of authorised vehicle registration numbers may be obtained from a local memory, or from a remote server.

The method then comprises identifying at least one authorised vehicle registration number which shares (i) the same number of characters and (ii) the same characters as the vehicle registration number to be recognised 160. This may comprise two sub-stages: (i) identifying at least one authorised vehicle registration number comprising the same number of characters as the vehicle registration number to be recognised; and (ii) identifying whether the at least one authorised vehicle registration number which comprises the same number of characters as the vehicle registration number to be recognised also comprises the same characters, for example wherein all characters are common to both the at least one authorised vehicle registration number and the vehicle registration number to be recognised.

The method further comprises determining whether two characters of the at least one authorised vehicle registration number and the vehicle registration number to be recognised are in different relative positions within the vehicle registration numbers, for example where at least two characters are out of sequence.

In this case, the method is then configured to determine whether the incorrectly placed, or out of sequence, characters are adjacent 164. If this is so, the method is then configured to send a signal that the vehicle registration number is recognised. As with the methods of FIGS. 1A to 1C, in some examples sending the signal that the vehicle registration number is recognised 150 may further comprise sending a signal to permit access of the vehicle to the restricted area.

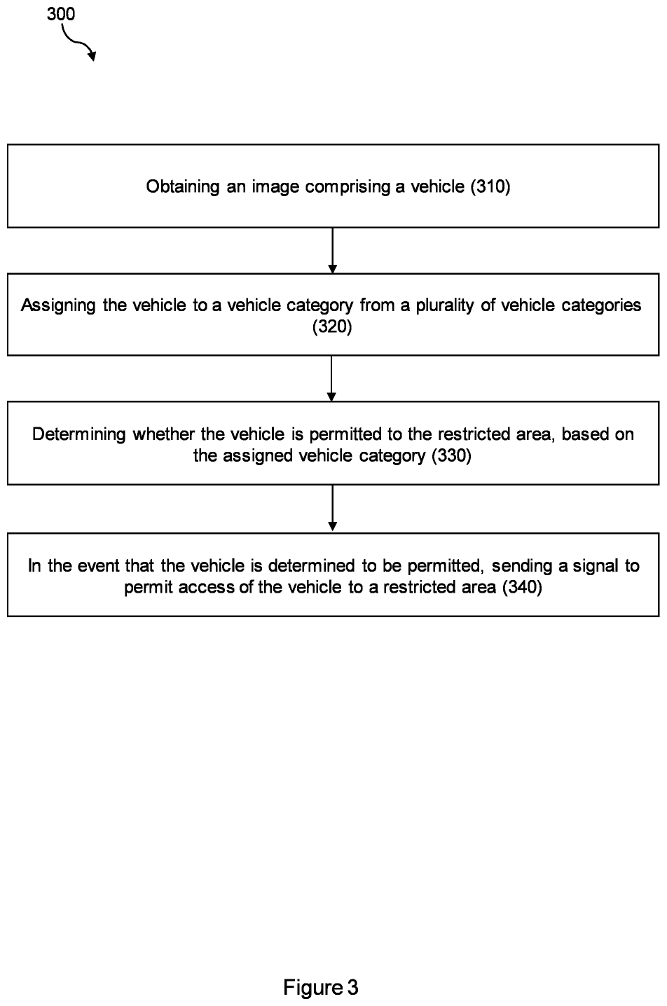

FIG. 3 shows an example method 300 for permitting vehicle access to a restricted area. This method may be configured to be performed by processor, for example a processor in an ANPR camera or other suitable image capturing device, in a barrier control unit, or in a separate processor unit, for example wherein the processor unit may be, an edge device, a remote device, such as a cloud-based remote server, or local to an ANPR camera and/or barrier system.

The method first comprises obtaining an image comprising the vehicle which intends to access the restricted area 310. The method then further comprises assigning the vehicle to a vehicle category from a plurality of vehicle categories 320 based on AI analysis of the image of the vehicle. Example techniques of AI-based image recognition may include at least one of image classification, object detection, and/or image segmentation. Example vehicle categories may include, but are not limited to, emergency vehicle, bus or other public transport vehicle, delivery vehicle, private vehicle, or other.

The method further comprises determining whether the vehicle is permitted to the restricted area 330, based on the assigned vehicle category, wherein at least a portion of the vehicle categories are permitted access to the restricted area.

If the vehicle is determined to be permitted based on its assigned category, the method further comprises sending a signal to permit access of the vehicle to a restricted area 340.

In some examples, the method of FIG. 3 may be combined with the vehicle registration number recognition methods of any of FIGS. 1 to 2. For example, where a vehicle is not permitted access to the restricted area based on the assigned vehicle category, the vehicle may be subject to the vehicle registration number recognition methods of any of FIGS. 1 to 2 where the method comprises sending the signal that to permit access to the vehicle in the event that the vehicle registration number is recognised.

Alternatively, in some examples, the signal to permit access of the vehicle to a restricted area 340 may only be sent if the vehicle is determined to be permitted based on its assigned category and the vehicle registration number is recognised in accordance with the vehicle registration number recognition methods of any of FIGS. 1 to 2.

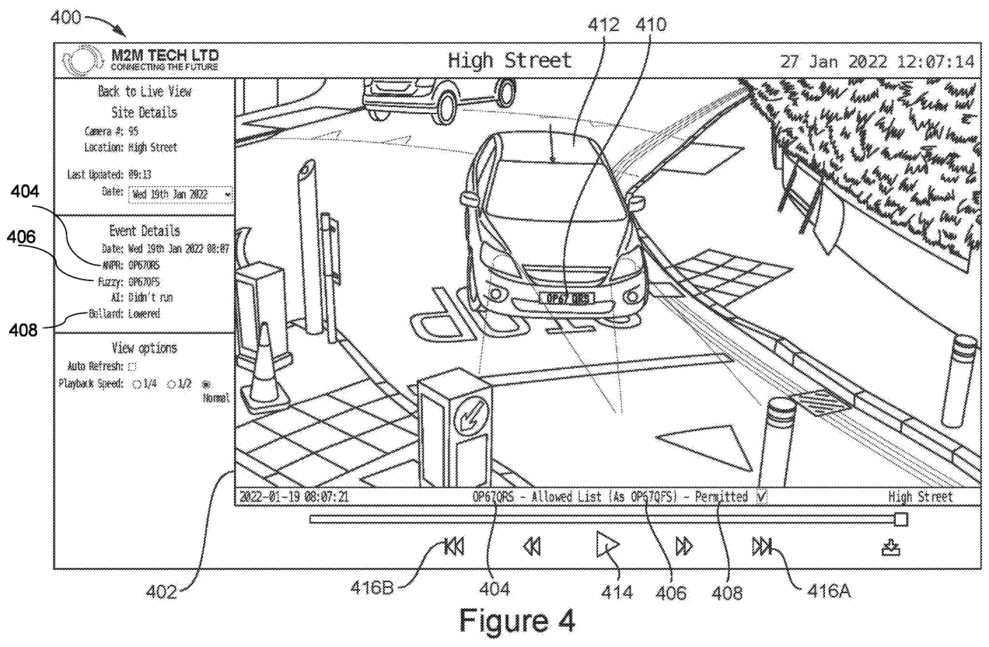

FIG. 4 depicts an example graphical user interface 400 configured for use with the present method. The graphical user interface 400 comprises an indication of the vehicle registration number to be recognised 404 and the authorised vehicle registration number it was considered to be recognised against 406 resulting from the method of vehicle registration number recognition, for example the method of any of FIGS. 1 to 2. The interface 400 also comprises an indication of the outcome of the recognition 408, in this case indicating that the vehicle registration number was recognised and permitted entry to a restricted area. In this example, permitting access to the vehicle to the restricted area comprised removing a physical barrier by lowering a bollard. In this example, the interface 400 also comprises an image 402 of the vehicle 412. The interface 400 also comprises supplementary information including the location, date, and time of the event.

In use, the user may be able to navigate through a plurality of vehicle recognition events using the play/pause button 414, and forward and backwards buttons 416A and 416B, wherein the plurality of events may be viewed in chronological order. An event may comprise any instance an image of a vehicle or vehicle registration number is obtained.

In the example shown, the vehicle registration number obtained is “OP67 QRS”. The method has identified authorised vehicle registration number “OP67 QRS” from a plurality of authorised vehicle registration numbers from a vehicle registration list. The method identified authorised vehicle registration number “OP67 QRS” as it fulfils the criteria of the method, for example the method of FIGS. 1A to 1C, because “OP67 QRS” has seven characters and “OP67 QRS” has six characters in common with “OP67 QRS” (O, P, 6, 7, Q, S), thus six characters is equal to the pre-determined threshold of one less common character than all characters (i.e. VRM-1). The common characters O, P, 6, 7, Q, S are in the same relative position or sequence in both vehicle registration numbers. Thus, the vehicle registration number “OP67 QRS” is recognised as “OP67 QRS”. The method then sent a signal to a barrier control unit to remove the barrier, in this case the bollard, to permit the vehicle access.

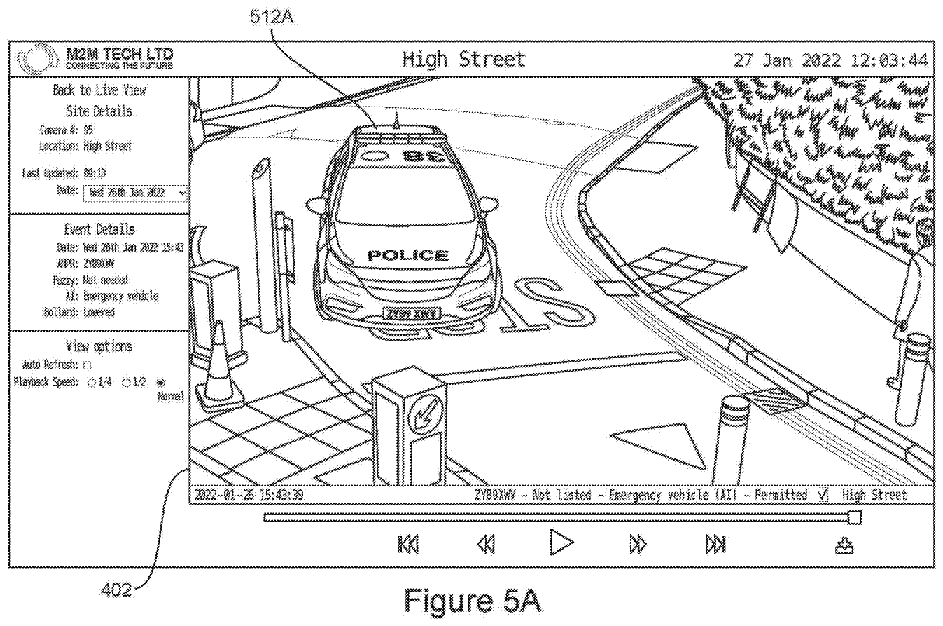

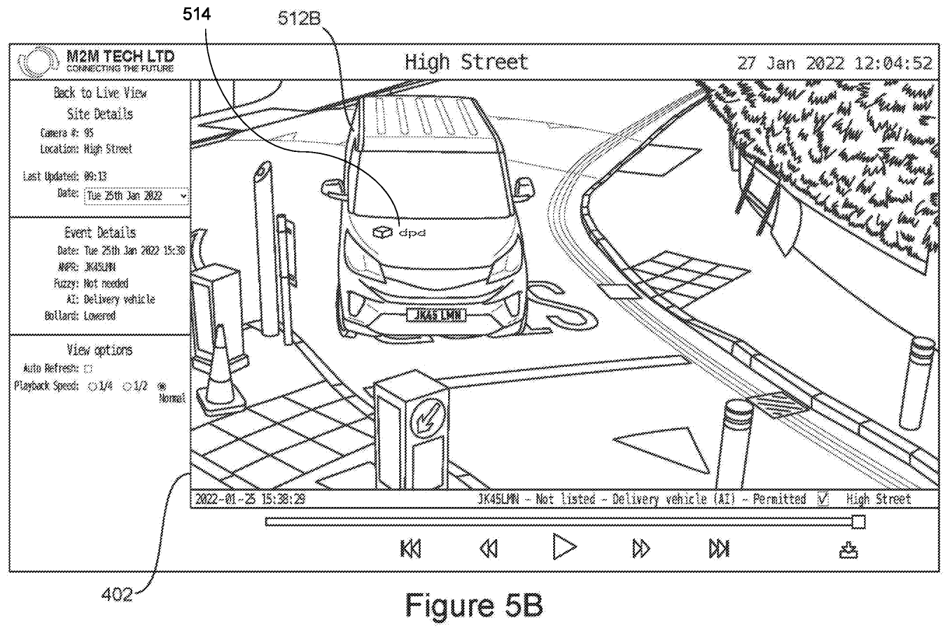

FIGS. 5A and 5B illustrate the example graphical interface of FIG. 4, depicting different scenarios based on the method receiving different images 402 of different vehicles 512A and 512B. In FIG. 5A, the image 402 depicts a police vehicle 512A. In FIG. 5B, the image 402 depicts a delivery vehicle 512B.

In the example shown in FIG. 5A, the vehicle registration number obtained is “ZY89 XWV”. The method of vehicle registration number recognition, for example the method of any of FIGS. 1 to 2, does not identify any authorised vehicle registration number that fulfils the criteria to recognise the vehicle registration number.

However, in this case, the vehicle 512A is determined to be an emergency vehicle based on AI image recognition from the image 402. The method therefore sends a signal to permit access to the vehicle to the restricted area because, in this example, emergency vehicles, for example including police vehicles, ambulances, and fire vehicles, are subcategory of vehicles that are permitted to access the restricted area, regardless of the vehicle registration number.

The same applies to the vehicle 512B shown in FIG. 5B which is determined to be a delivery vehicle based on AI image recognition from the image 402. In this example, delivery vehicles are also a permitted category of vehicle. Classification of a vehicle by image recognition may be based on at least one of, but not limited to, colour, shape, presence of a recognised logo, and/or presence of a recognised trade name or text, for example the logo and/or text 514 on the vehicle 512B.

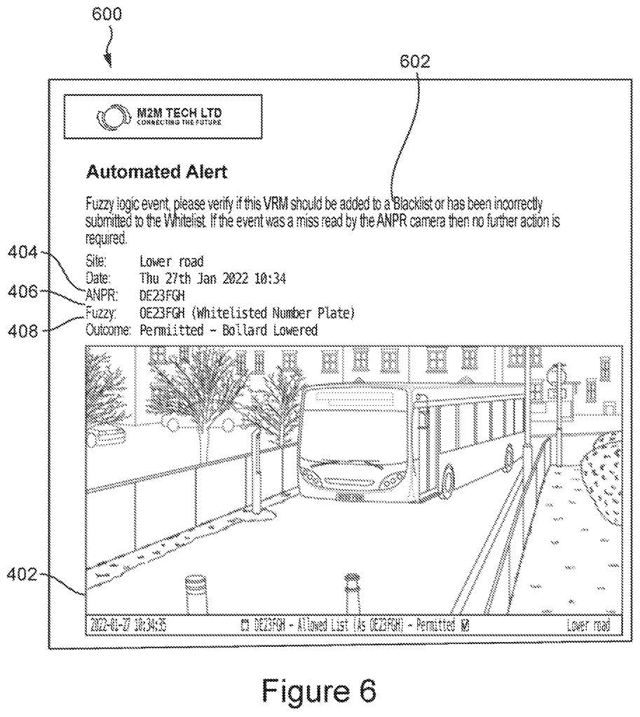

FIG. 6 illustrates an example alert 600 sent to an administrator, for example according to the method of any of FIGS. 1 to 3. In this example, the alert comprises an indication of the vehicle registration number identified 404 and the authorised vehicle registration number it was considered to be recognised against 406, for example according to the vehicle registration number recognition method of any of FIGS. 1 to 2. The alert also comprises an indication of the outcome of the recognition 408, in this case indicating that the vehicle registration number was recognised and permitted entry to a restricted area. In this example, permitting access to the vehicle to the restricted area comprised lowering the bollard. Optionally, the alert may further comprise an image 402 of the vehicle 412. In some examples, sending the alert further comprises sending a signal to update the list or database of authorised vehicle registration numbers with the recognised vehicle registration number. In this example, the alert sends a verification request 602 to the administrator to confirm that the vehicle registration number has been correctly submitted to the Whitelist (i.e., the vehicle registration list).

The alert may be configured to indicate to the administrator that a vehicle or vehicle registration number was recognised and permitted access to a restricted area despite being a non-identical match to the plurality of authorised vehicle registration numbers. The alert may further be configured to request verification of at least one of (i) the vehicle registration number has correctly or incorrectly been submitted to the whitelist, or (ii) whether the vehicle registration number should be added to the blacklist (for example to prevent future trespassing events where the vehicle was incorrectly permitted access to the restricted area in a false-positive vehicle recognition event).

In use, the alert may be sent to an administrator in the event that a vehicle or vehicle registration number was recognised and permitted access to a restricted area despite being a non-identical match to the plurality of authorised vehicle registration numbers, or in the event that a vehicle was permitted access to a restricted area based on the vehicle being assigned to a category of permitted vehicle types, for example as a result of image recognition based on AI.

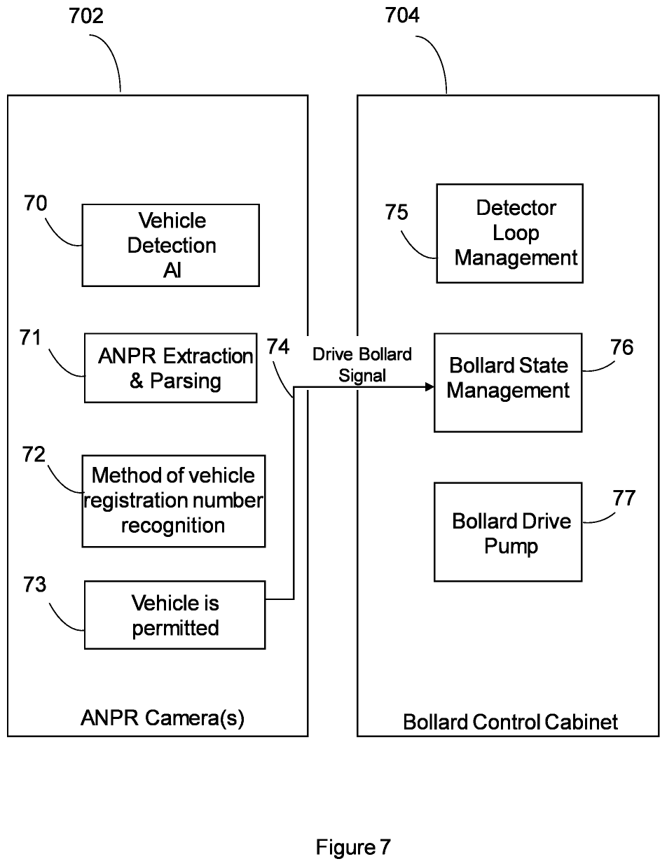

FIG. 7 shows an example system configured to perform the methods of the present invention, for example the methods of FIGS. 1 to 2. This system comprises an image capturing means 702 and a control unit 704. In this example, the image capturing means 702 is a ANPR camera, however any other suitable means may be used. The image capturing means 702 comprises a local processor.

In this example, the control unit 704 is a rising bollard control unit. However, the skilled person will understand the control unit 704 may be any control unit configured to displace a barrier from a road or highway access point, for example a physical barrier, such as a gate, rising bollard, or barrier. The control unit 804 comprises a local processor.

The image capturing means 702 is configured to detect the presence of a vehicle 70, for example using AI or any other suitable method such as motion detection. The image capturing means 702 is further configured to obtain an image of the vehicle registration number, wherein the image optionally includes the vehicle.

The image capturing means 702 is then further configured to identify the characters of the vehicle registration number 71, for example where identification comprises extraction and parsing of the characters.

The local processor of the image capturing means 702 is further configured to perform a method of vehicle registration number recognition, for example according to any of the methods of FIGS. 1 to 2, to compare the vehicle registration number to a plurality of authorised vehicle registration numbers. In some examples, the plurality of authorised vehicle registration numbers are stored in a list or database. In some examples, the image capturing means 702 may further comprise a memory, wherein the plurality of authorised vehicle registration numbers are stored locally. In some examples, the image capturing means 702 is configured to obtain the plurality of authorised vehicle registration numbers from a remote server.

In the event that the processor identifies that the vehicle is recognised 73, in accordance with any of the methods of FIGS. 1 to 2, the image capturing means 702 is configured to send a signal 74 to the control unit 704 to displace and/or remove the barrier. In some examples, the image capturing means 702 may be configured to send the signal via a wired connection between the image capturing means 702 and the control unit 704. In some examples, the image capturing means 702 further comprises a wireless communication interface, which may comprise a short-range wireless interface (e.g., a Bluetooth® or Wi-Fi® interface) and/or a long-range wireless interface, for example a telecommunications interface (e.g., a 3G, 4G or 5G interface), wherein the image capturing means 702 may be configured to send the signal via wireless communication interface to the control unit 704.

Upon receiving the signal, the control unit 704 is configured to displace and/or remove the barrier, for example by sending a signal to a barrier drive system 77, to remove or displace the barrier to allow the vehicle to pass. In some examples, the control unit 704 is configured to only displace and/or remove the barrier provided that additional safety criteria are fulfilled, for example using a detector loop management system 75. In this case, the control unit 704 is only configured to displace and/or remove the barrier in response to the signal 74 from the image capturing means 702 provided that a detector loop signals 75 to the control unit 704 that a vehicle is detected.

In the case that the signal is sent from the processor to the barrier control unit to displace and/or remove the barrier 74, but the barrier control unit does not displace or remove the barrier, for example due to the detector loop safety criteria not being fulfilled 75, the processor may, optionally, be configured to resend the signal after a pre-determined time window. In some examples, the processor may, optionally, be configured to repeat the signal at pre-determined time intervals, for example, but not limited to every 5 s, until the barrier control unit does displace or remove the barrier. For example, the processor may repeat the signal 74 at pre-determined time intervals until the detector loop signals to the barrier control system that a vehicle is detected 75, and in response the barrier control system signals to the drive mechanism to displace or remove the barrier 77. This may be advantageous to prevent system glitches wherein the vehicle is recognised and permitted by the processor before the safety detector loop detects the presence of a vehicle. This scenario could otherwise freeze the system which prevents the barrier being removed or displaced unless both the safety criteria (i.e. vehicle detection by the detector loop) and recognition by the local processor are simultaneously fulfilled. In existing barrier systems, the vehicle would then be denied entry until the vehicle leaves and re-approaches the barrier, re-triggering the entire system and method. However, as provided by the present method, by repeating the signal 74 from the processor at pre-determined intervals, it allows the system to repeatedly reassess the conditions for entry. For example, in a scenario where a vehicle slowly approaches the barrier, the processor may recognise the vehicle before the safety detector loop detects the presence of a vehicle. Thus, when the processor sends a signal 74 to the barrier control unit to displace the barrier, the barrier will not be displaced as the safety criteria (i.e. vehicle detection by the detector loop 75) is not fulfilled. However, as the vehicle slowly approaches the barrier, the detector loop will eventually detect the vehicle. As the signal 74 to the barrier control unit is repeated at pre-determined intervals, eventually the safety signal provided by the detector loop 75 and the signal 74 to the barrier control unit to displace the barrier will be simultaneously fulfilled, thus the barrier control system will signal to the barrier drive mechanism to remove or displace the barrier 77.

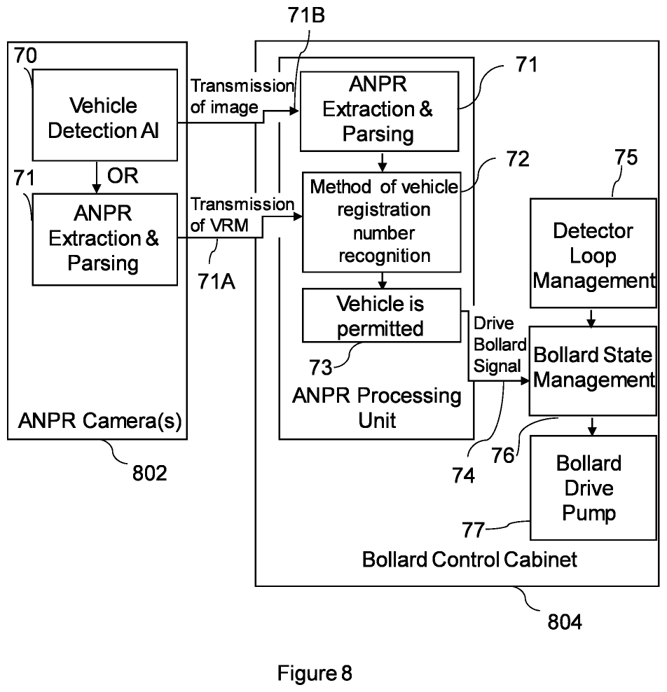

FIG. 8 shows an example system configured to perform the methods of vehicle registration number recognition of the present invention, for example the methods of FIGS. 1 to 2. This system comprises an image capturing means 802 and a control unit 804. In this example, the image capturing means 802 is a ANPR camera, however any other suitable means may be used.

In this example, the control unit 804 is a rising bollard control unit. However, the skilled person will understand the control unit 804 may be any control unit configured to displace a barrier from a road or highway access point, for example a physical barrier, such as a gate, rising bollard, or barrier. The control unit 804 comprises a local processor and a barrier control unit.

The image capturing means 802 is configured to detect the presence of a vehicle 70, for example using AI or any other suitable means such as motion detection. The image capturing means 802 is further configured to obtain an image of the vehicle registration number, wherein the image optionally includes the vehicle.

In some examples, the image capturing means 802 is then further configured to identify the characters of the vehicle registration number 71, for example where identification comprises extraction and parsing of the characters. The image capturing means 802 is then configured to send an indication of the vehicle registration number to be recognised 71A to the control unit 804. In other examples, the image capturing means 802 is configured to send the image 71B to the control unit 804, wherein the local processor of the control unit 804 is configured to identify the characters of the vehicle registration number 71, for example where identification comprises extraction and parsing of the characters.

In some examples, the image capturing means 802 may be configured to send the image and/or signal via a wired connection between the image capturing means 802 and the control unit 804. In some examples, the image capturing means 802 further comprises a wireless communication interface, which may comprise a short-range wireless interface (e.g. a Bluetooth® or Wi-Fi® interface) and/or a long-range wireless interface, for example a telecommunications interface (e.g. a 3G, 4G or 5G interface), wherein the image capturing means 802 may be configured to send the image and/or signal between the image capturing means 802 and the control unit 804 via the wireless interface.

The local processor of the control unit 804 is then further configured to perform a method of vehicle registration number recognition to compare the vehicle registration number to a plurality of authorised vehicle registration numbers, for example according to any of the methods of FIGS. 1 to 2. In some examples, the plurality of authorised vehicle registration numbers are stored in a list or database. In some examples, the control unit 804 may further comprise a memory, wherein the plurality of authorised vehicle registration numbers are stored locally. In some examples, control unit 804 is configured to obtain the plurality of authorised vehicle registration numbers from a remote server.

In the event that the local processor identifies that the vehicle is recognised and permitted 73, for example in accordance with any of the methods of FIGS. 1 to 2, the control unit 804 is configured to send a signal to the barrier control unit to displace and/or remove the barrier 74.

Upon receiving the signal 76, the barrier control system is configured to signal to displace and/or remove the barrier 77, in this case the at least one bollard, by signalling to the barrier drive mechanism to allow the vehicle to pass. In some examples, the control unit 804 is configured to only displace and/or remove the barrier provided that additional safety criteria are fulfilled. In this case, the barrier control unit 804 is only configured to displace and/or remove the barrier in response to the signal from the local processor, provided that a detector loop signals to the barrier control unit 804 that a vehicle is detected.

In the case that the signal 74 is sent from the processor to the barrier control system, but the barrier control system does not signal to displace or remove the barrier, for example due to the detector loop safety criteria not being fulfilled, the processor may, optionally, be configured to resend the signal after a pre-determined time window. In some examples, the processor may, optionally, be configured to repeat the signal at pre-determined time intervals, for example, but not limited to every 5 s, until the barrier control unit does displace or remove the barrier. For example, the processor may repeat the signal 74 at pre-determined time intervals until the detector loop signals 75 to the barrier control system that a vehicle is detected, and in response the barrier control 76 signals to the barrier drive mechanism to displace or remove the barrier 77.

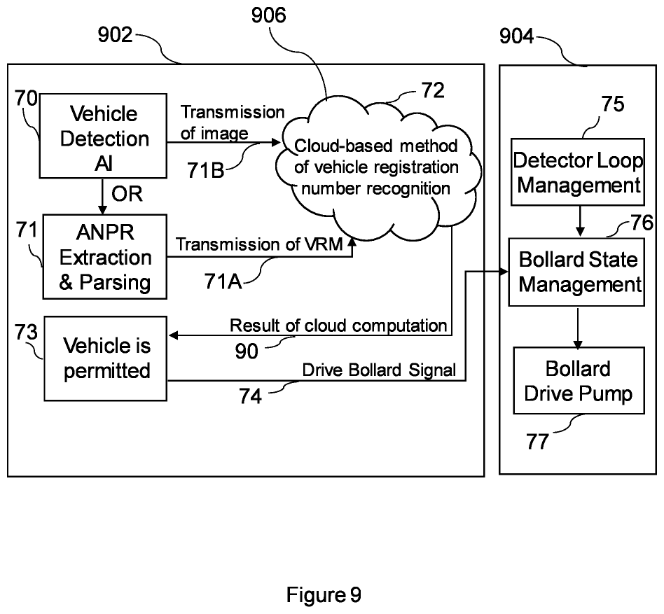

FIG. 9 shows an example system configured to perform the methods vehicle registration number recognition of the present invention, for example the methods of FIGS. 1 to 2. This system comprises an image capturing means 902, a remote server 906, and a control unit 904. In this example, the image capturing means 902 is a ANPR camera, however any other suitable means may be used. The image capturing means 902 further comprises a wireless communication interface, which may comprise a short-range wireless interface (e.g. a Bluetooth® or Wi-Fi® interface) and/or a long-range wireless interface, for example a telecommunications interface (e.g. a 3G, 4G or 5G interface).

In this example, the control unit 904 is a rising bollard control unit. However, the skilled person will understand the control unit 904 may be any control unit configured to displace a barrier from a road or highway access point, for example a physical barrier, such as a gate, rising bollard, or barrier. The control unit 904 comprises a local processor and a barrier control unit.

The image capturing means 902 is configured to detect the presence of a vehicle 70, for example using AI or any other suitable means such as motion detection. The image capturing means 902 is further configured to obtain an image of the vehicle registration number, wherein the image optionally includes the vehicle.

In some examples, the image capturing means 902 is then further configured to identify the characters of the vehicle registration number 71, for example where identification comprises extraction and parsing of the characters. The image capturing means 902 is then configured to send an indication of the vehicle registration number to be recognised 71A to the remote server 906. In other examples, the image capturing means 902 is configured to send the image of at least the vehicle registration number 71B to the remote server 906, wherein the remote server 906 is configured to identify the characters of the vehicle registration number, for example where identification comprises extraction and parsing of the characters.

The image capturing means 902 may be configured to send the image 71B and/or indication of the vehicle registration number to be recognised 71A between the image capturing means 902 and the remote server 906 via the wireless interface.

The remote server 906 is then configured to perform a method of vehicle registration number recognition to compare the vehicle registration number to a plurality of authorised vehicle registration numbers, for example according to any of the methods of FIGS. 1 to 2. In some examples, the plurality of authorised vehicle registration numbers are stored in a list or database at the remote server 906.

In the event that the remote server 906 identifies that the vehicle is recognised, for example in accordance with any of the methods of FIGS. 1 to 2, the remote server 906 is configured to send a signal to the image capturing means 902 indicating that the vehicle is recognised and permitted 90. In response to receiving the signal 90 from the remote server 906, the image capturing means 702 is configured to send a signal 74 to the control unit 904 to displace or remove the barrier.

Upon receiving the signal 74, the barrier control system 76 is configured to signal to the barrier drive mechanism displace and/or remove the barrier 77, in this case the at least one bollard, to allow the vehicle to pass. In some examples, the control unit 904 is configured to only displace and/or remove the barrier provided that additional safety criteria are fulfilled. In this case, the barrier control system is only configured to signal to displace and/or remove the barrier in response to the signal 74 from the local processor provided that the detector loop signals to the barrier control system that a vehicle is detected 75.

In the case that the signal 74 is sent from the processor to the barrier control system, but the barrier control system does not signal to displace or remove the barrier, for example due to the detector loop safety criteria not being fulfilled, the processor may, optionally, be configured to resend the signal after a pre-determined time window. In some examples, the processor may, optionally, be configured to repeat the signal at pre-determined time intervals, for example, but not limited to every 5 s, until the barrier control unit does displace or remove the barrier. For example, the processor may repeat the signal 74 at pre-determined time intervals until the detector loop signals 75 to the barrier control system that a vehicle is detected, and in response the barrier control 76 signals to the barrier drive mechanism to displace or remove the barrier 77.

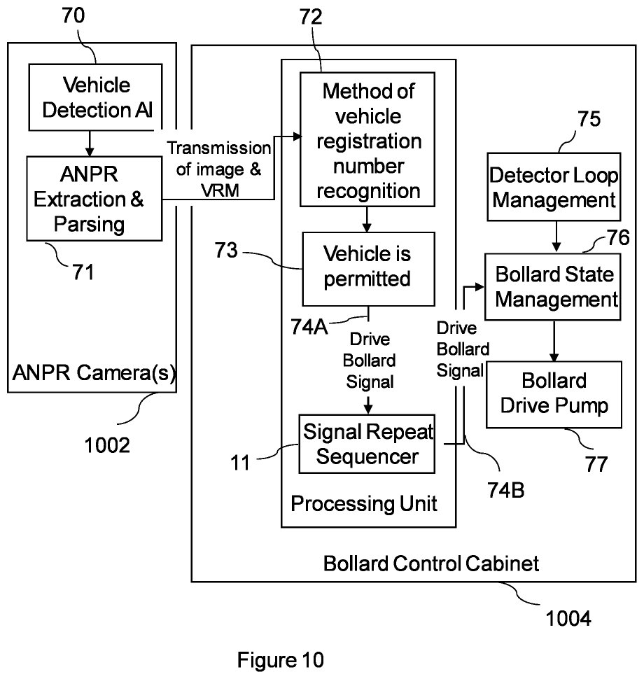

FIG. 10 shows an example system configured to perform the methods of vehicle registration number recognition of the present invention, for example the methods of FIGS. 1 to 2. This system comprises an image capturing means 1002 and a control unit 1004. In this example, the image capturing means 1002 is a ANPR camera, however any other suitable means may be used.

In this example, the control unit 1004 is a rising bollard control unit. However, the skilled person will understand the control unit 1004 may be any control unit configured to displace a barrier from a road or highway access point, for example a physical barrier, such as a gate, rising bollard, or barrier. The control unit 1004 comprises a local processor and a barrier control unit.

The image capturing means 1002 is configured to detect the presence of a vehicle 70, for example using AI or any other suitable means such as motion detection. The image capturing means 1002 is further configured to obtain an image of the vehicle registration number, wherein the image optionally includes the vehicle.

In some examples, the image capturing means 1002 is then further configured to identify the characters of the vehicle registration number 71, for example where identification comprises extraction and parsing of the characters. The image capturing means 1002 is then configured to send an indication of the vehicle registration number to be recognised to the control unit 1004. In other examples, the image capturing means 1002 is configured to send the image to the control unit 1004, wherein the local processor of the control unit 1004 is configured to identify the characters of the vehicle registration number, for example where identification comprises extraction and parsing of the characters.

In some examples, the image capturing means 1002 may be configured to send the image and/or signal via a wired connection between the image capturing means 1002 and the control unit 1004. In some examples, the image capturing means 1002 further comprises a wireless communication interface, which may comprise a short-range wireless interface (e.g. a Bluetooth® or Wi-Fi® interface) and/or a long-range wireless interface, for example a telecommunications interface (e.g. a 3G, 4G or 5G interface), wherein the image capturing means 1002 may be configured to send the image and/or signal between the image capturing means 1002 and the control unit 1004 via the wireless interface.

The processor of the control unit 1004 is then further configured to perform a method of vehicle registration number recognition to compare the vehicle registration number to a plurality of authorised vehicle registration numbers, for example according to any of the methods of FIGS. 1 to 2. In some examples, the plurality of authorised vehicle registration numbers are stored in a list or database. In some examples, the control unit 1004 may further comprise a memory, wherein the plurality of authorised vehicle registration numbers are stored locally. In some examples, control unit 1004 is configured to obtain the plurality of authorised vehicle registration numbers from a remote server.

In the event that the processor identifies that the vehicle is recognised, for example in accordance with any of the methods of FIGS. 1 to 2, the control unit 1004 is configured to send a signal 74A or 74B to the barrier control system to displace and/or remove the barrier.

Upon receiving the signal, the barrier control system 76 is configured to signal to the barrier drive mechanism to displace and/or remove the barrier 77, in this case the at least one bollard, to allow the vehicle to pass. In some examples, the control unit 1004 is configured to only displace and/or remove the barrier provided that additional safety criteria are fulfilled. In this case, the barrier control system is only configured to signal to the drive mechanism 77 to displace and/or remove the barrier in response to the signal from the local processor 74 provided that a detector loop signals to the barrier control system that a vehicle is detected 75.

In the case that the signal 74 is sent from the processor to the barrier control system, but the barrier control system does not signal to displace or remove the barrier, for example due to the detector loop safety criteria not being fulfilled, the processor may, optionally, be configured to resend the signal after a pre-determined time window via a signal repeat sequencer 11. In some examples, the signal repeat sequencer 11 may be configured to repeat the signal at pre-determined time intervals, for example, but not limited to every 5 s, until the barrier control system signals to the drive mechanism 77 to displace or remove the barrier signal repeat sequencer 11.

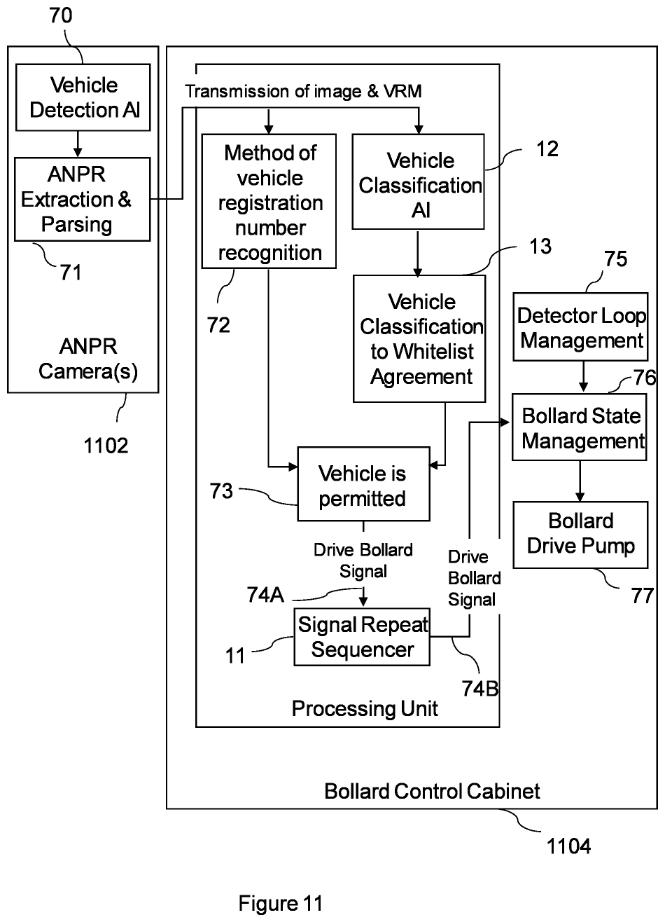

FIG. 11 shows an example system configured to perform the methods of vehicle registration number recognition and vehicle recognition of the present invention, for example the methods of FIGS. 1 to 3. This system comprises an image capturing means 1102 and a control unit 1104. In this example, the image capturing means 1102 is a ANPR camera, however any other suitable means may be used.

In this example, the control unit 1104 is a rising bollard control unit. However, the skilled person will understand the control unit 1104 may be any control unit configured to displace a barrier from a road or highway access point, for example a physical barrier, such as a gate, rising bollard, or barrier. The control unit 1104 comprises a local processor and a barrier control unit.

The image capturing means 1102 is configured to detect the presence of a vehicle 70, for example using AI or any other suitable means such as motion detection. The image capturing means 1102 is further configured to obtain an image of the vehicle registration number and the corresponding vehicle.

In some examples, the image capturing means 1102 is then further configured to identify the characters of the vehicle registration number 71, for example where identification comprises extraction and parsing of the characters. The image capturing means 1102 is then configured to send the image and an indication of the vehicle registration number to be recognised to the control unit 1104. In other examples, the image capturing means 1102 is configured to send the image to the control unit 1104, wherein the local processor of the control unit 1104 is configured to identify the characters of the vehicle registration number, for example where identification comprises extraction and parsing of the characters.

In some examples, the image capturing means 1102 may be configured to send the image and/or signal via a wired connection between the image capturing means 1102 and the control unit 1104. In some examples, the image capturing means 1102 further comprises a wireless communication interface, which may comprise a short-range wireless interface (e.g. a Bluetooth® or Wi-Fi® interface) and/or a long-range wireless interface, for example a telecommunications interface (e.g. a 3G, 4G or 5G interface), wherein the image capturing means 1102 may be configured to send the image and/or signal between the image capturing means 1102 and the control unit 1104 via the wireless interface.

The local processor of the control unit 1104 is then further configured to perform a vehicle registration number recognition method to compare the vehicle registration number to a plurality of authorised vehicle registration numbers, for example according to any of the methods of FIGS. 1 to 2. In some examples, the plurality of authorised vehicle registration numbers are stored in a list or database. In some examples, the control unit 1104 may further comprise a memory, wherein the plurality of authorised vehicle registration numbers are stored locally. In some examples, control unit 1104 is configured to obtain the plurality of authorised vehicle registration numbers from a remote server.

The local processor of the control unit 1104 is then further configured to perform a vehicle classification method 12 to assign the vehicle to a vehicle category, based on image recognition of the vehicle, for example according to the method of FIG. 3. The processor is then configured to determine whether the vehicle is permitted based on the assigned vehicle category by comparing the vehicle category to a selection of vehicle categories which permitted 13, for example according to the method of FIG. 3.

In some examples, the processor may determine that the vehicle may is permitted in the event that the vehicle registration number is recognised according to method step 72, or in the event that the vehicle is permitted based on the assigned vehicle category according to method step 13. Alternatively, in some examples, the signal to permit access of the vehicle to a restricted area 340 may only be sent if the vehicle is determined to be permitted based on its assigned category 13 and the vehicle registration number is recognised 72.

In the event that the local processor identifies that the vehicle is recognised/permitted, for example in accordance with any of the methods of FIGS. 1 to 3, the control unit 1104 is configured to send a signal to the barrier control unit to displace and/or remove the barrier.

Upon receiving the signal, the barrier control unit 1104 is configured to displace and/or remove the barrier, in this case the at least one bollard, to allow the vehicle to pass. In some examples, the control unit 1104 is configured to only displace and/or remove the barrier provided that additional safety criteria are fulfilled. In this case, the barrier control unit 1104 is only configured to displace and/or remove the barrier in response to the signal from the local processor, provided that a detector loop signals to the barrier control unit 1104 that a vehicle is detected.

In the case that the signal is sent from the local processor to the barrier control unit to displace and/or remove the barrier, but the barrier control unit does not displace or remove the barrier, for example due to the detector loop safety criteria not being fulfilled, the local processor may, optionally, be configured to resend the signal after a pre-determined time window. In some examples, the processor may, optionally, be configured to repeat the signal at pre-determined time intervals, for example, but not limited to every 5 s, until the barrier control unit does displace or remove the barrier. For example, the processor may repeat the signal at pre-determined time intervals until the detector loop signals to the barrier control unit 1104 that a vehicle is detected, and the barrier control unit displaces or removes the barrier. This may be advantageous to prevent system glitches wherein the vehicle is recognised and permitted by the local processor before the safety detector loop detects the presence of a vehicle. This scenario could otherwise freeze the system which prevents the barrier being removed or displaced unless both the safety criteria (i.e. vehicle detection by the detector loop) and recognition by the local processor are simultaneously fulfilled. In existing barrier systems, the vehicle would then be denied entry until the vehicle leaves and re-approaches the barrier, re-triggering the entire system and method. However, as provided by the present method, by repeating the signal from the processor at pre-determined intervals, it allows the system to repeatedly reassess the conditions for entry. For example, in a scenario where a vehicle slowly approaches the barrier, the local processor may recognise the vehicle before the safety detector loop detects the presence of a vehicle. Thus, when the local processor sends a signal to the barrier control unit to displace the barrier, the barrier will not be displaced as the safety criteria (i.e. vehicle detection by the detector loop) is not fulfilled. However, as the vehicle slowly approaches the barrier, the detector loop will subsequently detect the vehicle. As the signal to the barrier control unit is repeated at pre-determined intervals, eventually the safety criteria and the signal to the barrier control unit to displace the barrier would be simultaneously fulfilled, thus removing, or displacing the barrier.

In the context of the present disclosure other examples and variations of the apparatus and methods described herein will be apparent to a person of skill in the art.

Although the FIGS. 4 to 11 of the present invention are discussed in relation to physical barrier control, the skilled person will understand that the disclosed method for vehicle registration number recognition may be used in other settings where ANPR is employed. For example, the method of the present invention may be used to identify stolen vehicles. In this example, the vehicle registration numbers of stolen vehicles are obtained, for example being added to the list of authorised vehicle registration numbers. In the event that a vehicle registration number is recognised in comparison to the list of stolen vehicle registration numbers as detailed by the method of the present invention, a signal is sent to alert the authorities, for example including the last seen location of the stolen vehicle to help the vehicle be recovered. This may be particularly helpful to detect stolen vehicles wherein the vehicle registration plate has been illegally modified to disguise the stolen plate, for example where a “0” is illegally modified into an “8”. Supplementary information about the vehicle may also be cross-checked using image recognition, for example based on AI. In this example, at least one of vehicle type, make, model and/or colour may be detected from an image of the vehicle and vehicle registration number.

Another example application for the method present invention is to permit or disallow vehicles access to restricted areas to implement virtual barrier control. For example, in the event that a vehicle accessing a restricted area is recognised by the method as being permitted, no action is taken. However, for virtual barriers, the method may also be configured for the inverse, for example in the event that the vehicle or vehicle registration number is not recognised as being permitted, sending a signal to prevent access or register a traffic offence, for example issuing a fine to the trespassing vehicle registration number.

1. A computer-implemented method for vehicle registration number recognition, the method comprising:
obtaining a vehicle registration number to be recognized, comprising a plurality of characters;
obtaining a plurality of authorized vehicle registration numbers; and
comparing the vehicle registration number to be recognized with the plurality of authorized vehicle registration numbers, wherein comparing comprises:
identifying the number of characters in common between the vehicle registration number to be recognized and each of the plurality of authorized vehicle registration numbers;
determining whether the number of characters in common between the vehicle registration number to be recognized and each authorized vehicle registration number is above a pre-determined threshold; and
in the event that the number of characters in common between the vehicle registration number to be recognized and at least one authorized vehicle registration number is above the pre-determined threshold, sending a signal that the vehicle registration number is recognized.

2. The method of claim 1, wherein the pre-determined threshold is all characters of the vehicle registration number to be recognized minus one.

3. The method of claim 1, wherein determining whether the number of characters in common between the vehicle registration number to be recognized and each authorized vehicle registration number is above a pre-determined threshold comprises:
determining whether the number of characters in common is above a pre-determined threshold but less than all characters; and
sending the signal that the vehicle registration number is recognized comprises sending the signal in the event that the number of characters in common between the vehicle registration number to be recognized and at least one authorized vehicle registration number is above the pre-determined threshold but less than all characters.

4. The computer implemented method of claim 1, wherein in the event that the number of characters in common between the vehicle registration number to be recognized and at least one authorized vehicle registration number is above a pre-determined threshold, comparing the vehicle registration number to be recognized further comprises determining whether the common characters of the vehicle registration number to be recognized and the at least one authorized vehicle registration number are in the same relative position; and
in the event that the common characters are in the same relative position in the vehicle registration number to be recognized and the at least one authorized vehicle registration number, sending the signal that the vehicle registration number is recognized.

5. The method of claim 1, wherein comparing the vehicle registration number to be recognized with the plurality of authorized vehicle registration numbers further comprises:
identifying at least one authorized vehicle registration number wherein the at least one authorized vehicle registration number comprises (i) the same number of characters as the vehicle registration number to be recognized, and (ii) the same characters as the vehicle registration number to be recognized;
determining the relative position of the characters of the vehicle registration number to be recognized and the characters of the at least one authorized vehicle registration number comprising (i) the same number of characters as the vehicle registration number to be recognized, and (ii) the same characters as the vehicle registration number to be recognized;
in the event that (i) all the characters minus two are in the same relative position, and (ii) the two incorrectly positioned characters are adjacent, sending a signal that the vehicle registration number is recognized.

6. The method of claim 1, wherein obtaining the plurality of authorized vehicle registration numbers comprises obtaining a list or database comprising the plurality of authorized vehicle registration numbers,
optionally wherein the list or database comprising the plurality of authorized vehicle registration numbers further comprises at least one indication of a property of the vehicle corresponding to each authorized vehicle registration number; and the method further comprising:
obtaining an image comprising the vehicle registration number to be recognized and the corresponding vehicle;
obtaining at least one indication of a property of the vehicle by image recognition, based on the image of the vehicle;
in the event that the vehicle registration number is recognized, comparing the indication of the property of the vehicle from the image and the obtained indication of the property of the vehicle corresponding to the authorized vehicle registration number; and
in the event that the at least one indication of the property of the vehicle from the image and the at least one obtained indication of the property of the vehicle corresponding to the authorized vehicle registration number are the same, sending a signal that the vehicle is recognized.

7. (canceled)

8. The method of claim 1, wherein in the event that the vehicle registration number is recognized, the method further comprises sending an alert to an administrator.

9. The method of claim 1, wherein sending the signal that the vehicle registration number and/or vehicle is recognized comprises sending a signal to permit access of the corresponding vehicle to a restricted area,
optionally wherein sending the signal to permit access of the vehicle to the restricted area comprises sending a signal to displace a road barrier; and
optionally wherein sending the signal to permit access of the vehicle comprises repeating the signal after a pre-determined time interval until access to the vehicle is granted.

10. (canceled)

11. (canceled)

12. The method of claim 9, further comprising:
obtaining an image comprising the vehicle registration number and the corresponding vehicle;
assigning the vehicle to a vehicle category from a plurality of vehicle categories, based on image recognition of the vehicle;
determining whether the vehicle is permitted to access the restricted area based on the assigned vehicle category, wherein a subset of the vehicle categories are permitted regardless of the vehicle registration number; and
in the event that the vehicle is permitted based on the assigned vehicle type, sending the signal to permit access of the vehicle to a restricted area.

13. The method of claim 1, wherein obtaining the vehicle registration number to be recognized comprises:
obtaining an image comprising the vehicle registration number; and
identifying the characters of the vehicle registration number.

14. A computer-implemented method for vehicle registration number recognition, the method comprising:
obtaining a vehicle registration number to be recognized, comprising a plurality of characters;
obtaining a plurality of authorized vehicle registration numbers;
identifying at least one authorized vehicle registration number from the plurality of authorized vehicle registration numbers, wherein the at least one authorized vehicle registration comprises (i) the same number of characters as the vehicle registration number to be recognized, and (ii) the same characters as the vehicle registration number to be recognized;
determining the relative position of the characters of the vehicle registration number to be recognized and the characters of the identified authorized vehicle registration number;
in the event that (i) at least two characters are not in the same position as an authorized vehicle registration number, and (ii) the incorrect at least two characters are adjacent, sending a signal that the vehicle registration number is recognized.

15. The method of claim 14, wherein obtaining the plurality of authorized vehicle registration numbers further comprises obtaining at least one indication of a property of a vehicle corresponding to each authorized vehicle registration number; and the method further comprises:
obtaining an image comprising the vehicle registration number to be recognized and the corresponding vehicle;
obtaining at least one indication of a property of the vehicle, based on image recognition of the image of the vehicle;
in the event that the vehicle registration number is recognized, comparing the indication of the property of the vehicle from the image and the indication of the corresponding property of the vehicle corresponding to the authorized vehicle registration number;
in the event that the at least one indication of the property of the vehicle from the image and the at least one obtained indication of the property of the vehicle corresponding to the authorized vehicle registration number are the same, sending a signal that the vehicle is recognized.

16. The method of claim 14, wherein sending the signal that the vehicle registration number, the vehicle, or both, are recognized comprises sending a signal to permit access of the corresponding vehicle to a restricted area,
optionally wherein sending the signal to permit access of the vehicle to the restricted area comprises sending a signal to displace a road barrier, and
optionally wherein sending the signal to permit access of the vehicle comprises repeating the signal after a pre-determined time interval until access to the vehicle is granted.

17. (canceled)

18. (canceled)

19. The method of claim 14, wherein in the event that the vehicle registration number, the vehicle, or both, are recognized, the method further comprises sending an alert to an administrator.

20-24. (canceled)

25. A computer-implemented method for vehicle registration number recognition, the method comprising:
obtaining a vehicle registration number to be recognized, comprising a plurality of characters;
sending a request to a server to identify the number of characters in common between the vehicle registration number to be recognized and each of the plurality of authorized vehicle registration numbers;
sending a request to a server to determine whether the number of characters in common between the vehicle registration number to be recognized and each of the plurality of authorized vehicle registration numbers is above a pre-determined threshold but less than all characters;
receiving an indication that the number of characters in common between the vehicle registration number to be recognized and at least one authorized vehicle registration number is above a pre-determined threshold but less than all characters;
sending a signal that the vehicle registration number is recognized.

26. The method of claim 25, wherein the pre-determined threshold is all characters of the vehicle registration number to be recognized minus one.

27. The method of claim 25, wherein the method further comprises:
sending a request to the server to determine whether the common characters of the vehicle registration number to be recognized and the at least one authorized vehicle registration number are in the same relative position;
receiving an indication that the common characters of the vehicle registration number to be recognized and the at least one authorized vehicle registration number are in the same relative position; and
sending the signal that the vehicle registration number is recognized in response to receiving the indications that (i) the number of characters in common between the vehicle registration number to be recognized and at least one authorized vehicle registration number is above a pre-determined threshold but less than all characters, and (ii) the common characters of the vehicle registration number to be recognized and the at least one authorized vehicle registration number are in the same relative position.

28. The method of claim 25, further comprising:
sending a request to the server to identify at least one authorized vehicle registration number wherein the at least one authorized vehicle registration number comprises (i) the same number of characters as the vehicle registration number to be recognized, and (ii) the same characters as the vehicle registration number to be recognized;
sending a request to the server to identify whether the at least one authorized vehicle registration number comprises (i) at least two characters not in the same relative position compared to the vehicle registration number to be recognized, and (ii) the at least two incorrectly positioned characters are adjacent;
receiving an indication that at least one authorized vehicle registration number comprises (i) the same number of characters as the vehicle registration number to be recognized, (ii) the same characters as the vehicle registration number to be recognized, (iii) at least two characters not in the same relative position compared to the vehicle registration number to be recognized, and (iv) the at least two incorrectly positioned characters are adjacent;
sending a signal that the vehicle registration number is recognized in response to receiving the indication that at least one authorized vehicle registration number comprises (i) the same number of characters as the vehicle registration number to be recognized, (ii) the same characters as the vehicle registration number to be recognized, (iii) at least two characters not the same relative position compared to the vehicle registration number to be recognized, and (iv) the at least two incorrectly positioned characters are adjacent.

29. A computer program product comprising instructions configured to program a programmable device to perform the method of claim 1.

30. An automatic number plate recognition camera comprising a processor configured to perform the method of claim 1.
